(19) United States
(12) Patent Application Publication
(10) Pub. No.: US 2005/0271798 A1
(43) Pub. Date: Dec. 8, 2005

(54) Electrode formation by lamination of particles onto a current collector

(75) Inventors: Linda Zhong, San Diego, CA (US); Xiaomei Xi, Carlsbad, CA (US)

Correspondence Address: c/o Mark Wardas;Maxwell Technologies, Inc., 9244 Balboa Ave, San Diego, CA, 92123, US

(73) Assignee: Maxwell Technologies, Inc., San Diego, CA (US)

(21) Appl. No.: 11/176,137

(22) Filed: Jul. 6, 2005

Related U.S. Application Data
(63) Continuation-in-part of application No. 11/116,882, filed on Apr. 27, 2005.
Application No. 11/116,882 is a continuation-in-part of application No. 10/817,701, filed on Apr. 2, 2004.

(51) Int. Cl. B05D 5/12; B05D 3/02

(52) U.S. Cl. 427/58; 427/372.2

(57) ABSTRACT

Particles of active electrode material, such as a fibrillized mixture of carbon, and binder are deposited onto a surface of a current collector sheet. The current collector sheet and the particles are processed in a high-pressure nip, such as a calender. As a result of the high-pressure processing, a film of active electrode material is formed on and bonded to the surface of the current collector sheet. The process is then repeated to form a second film on the second surface of the current collector sheet. In an embodiment, the particles are applied to both surfaces of the current collector sheet at the same time, followed by a pass through a calender. The current collector sheet with the bonded films is shaped into electrodes suitable for use in various electrical devices, including double layer capacitors.

### RELATED APPLICATIONS

The present Application is Continuation-In-Part of commonly assigned and copending U.S. patent application Ser. No. 11/116,882 filed Apr. 27, 2005, which is a Continuation-In-Part of commonly assigned and copending U.S. patent application Ser. No. 10/817,701 filed Apr. 2, 2004, which are incorporated herein by reference in their entirety.

### FIELD OF THE INVENTION

The present invention generally relates to fabrication of electrodes. More specifically, the present invention relates to electrodes with active electrode material laminated onto current collectors, and to energy storage devices, such as electrochemical double layer capacitors, made with such electrodes.

### BACKGROUND

Electrodes are widely used in many devices that store electrical energy, including primary (non-rechargeable) battery cells, secondary (rechargeable) battery cells, fuel cells, and capacitors. Important characteristics of electrical energy storage devices include energy density, power density, maximum charging rate, internal leakage current, equivalent series resistance (ESR), and durability, i.e., the ability to withstand multiple charge-discharge cycles. For a number of reasons, double layer capacitors, also known as supercapacitors and ultracapacitors, are gaining popularity in many energy storage applications. The reasons include availability of double layer capacitors with high power densities (in both charge and discharge modes), and with energy densities approaching those of conventional rechargeable cells.

Double layer capacitors use electrodes immersed in an electrolyte (an electrolytic solution) as their energy storage element. Typically, a porous separator immersed in and impregnated with the electrolyte ensures that the electrodes do not come in contact with each other, preventing electronic current flow directly between the electrodes. At the same time, the porous separator allows ionic currents to flow between the electrodes in both directions. As discussed below, double layers of charges are formed at the interfaces between the solid electrodes and the electrolyte. Double layer capacitors owe their descriptive name to these layers.

When electric potential is applied between a pair of electrodes of a double layer capacitor, ions that exist within the electrolyte are attracted to the surfaces of the oppositely-charged electrodes, and migrate towards the electrodes. A layer of oppositely-charged ions is thus created and maintained near each electrode surface. Electrical energy is stored in the charge separation layers between these ionic layers and the charge layers of the corresponding electrode surfaces. In fact, the charge separation layers behave essentially as electrostatic capacitors. Electrostatic energy can also be stored in the double layer capacitors through orientation and alignment of molecules of the electrolytic solution under influence of the electric field induced by the potential.

In comparison to conventional capacitors, double layer capacitors have high capacitance in relation to their volume and weight. There are two main reasons for these volumetric and weight efficiencies. First, the charge separation layers are very narrow. Their widths are typically on the order of nanometers. Second, the electrodes can be made from a porous material, having very large effective surface area per unit volume. Because capacitance is directly proportional to the electrode area and inversely proportional to the widths of the charge separation layers, the combined effects of the large effective surface area and narrow charge separation layers result in capacitance that is very high in comparison to that of conventional capacitors of similar size and weight. High capacitance of double layer capacitors allows the capacitors to receive, store, and release large amounts of electrical energy.

As has already been mentioned, equivalent series resistance is also an important capacitor performance parameter. Frequency response of a capacitor depends on the characteristic time constant of the capacitor, which is essentially a product of the capacitance and the capacitor's equivalent series resistance, or “RC.” To put it differently, equivalent series resistance limits both charge and discharge rates of a capacitor, because the resistance limits the current that flows into or out of the capacitor. Maximizing the charge and discharge rates is important in many applications.

Internal resistance also creates heat during both charge and discharge cycles. Heat causes mechanical stresses and speeds up various chemical reactions, thereby accelerating capacitor aging. Moreover, the energy converted into heat is lost, decreasing the efficiency of the capacitor. It is therefore desirable to reduce equivalent series resistance of capacitors.

Active materials used for electrode construction—activated carbon, for example—may have limited specific conductance. Thus, large contact area may be desired to minimize the interfacial contact resistance between the electrode and its terminal. Additionally, the material may have a relatively low tensile strength, needing mechanical support in some applications. For these reasons, electrodes often incorporate current collectors.

A current collector is typically a sheet of conductive material to which the active electrode material is attached. Aluminum foil is commonly used as the current collector of an electrode. In one electrode fabrication process, for example, a film that includes activated carbon powder (i.e., the active electrode material) is produced, and then attached to a thin aluminum foil using an adhesive layer. To improve the quality of the interfacial bond between the film of active electrode material and the current collector, the combination of the film and the current collector is processed in a pressure laminator, for example, a calender or another nip. Pressure lamination increases the bonding forces between the film and the current collector, and reduces the equivalent series resistance of the energy storage device that employs the electrode.

The use of an adhesive layer on the interface between the active electrode film and the current collector, while advantageous in some respects, has a number of disadvantages. Adhesive use increases the cost of materials consumed in the process of electrode fabrication, and adds steps to the fabrication process, such as applying and drying the adhesive. The adhesive may deteriorate with time and use, contributing to an increase in the equivalent series resistance of the electrode. In some double layer capacitors, for example, the electrolyte reacts chemically with the adhesive, causing the adhesive to weaken and the bond created by the adhesive to fail over time.

Thus, fabrication of an electrode typically involves several steps, including (1) production of an active electrode material film, and (2) lamination of the film onto a current collector. (Other steps may also be involved in the process, for example, production and treatment of a current collector.) Each step generally employs special equipment. Each step also takes time during the fabrication process. It would be desirable to simplify the electrode fabrication process, for example, by reducing the number of steps and the cost of the equipment needed for electrode fabrication. At the same time, quality of the resulting electrodes should not be unnecessarily compromised.

Therefore, it may be preferable to reduce or eliminate one or more steps used in the fabrication of electrodes.

### SUMMARY

A need thus exists for electrode fabrication techniques with a reduced number of process steps. Another need exists for electrodes made using the simplified techniques. Still another need exists for electrical devices, such as double layer capacitors and other electrical energy storage devices that employ electrodes made with these techniques.

Various embodiments of the present invention are directed to methods, electrodes, electrode assemblies, and electrical devices that satisfy one or more of these needs. An exemplary embodiment of the invention herein disclosed is a method of making an electrode. According to this method, fibrillized particles of active electrode material are deposited on a first surface of a current collector sheet. The current collector sheet and the fibrillized particles are then calendered to obtain a first active electrode material film bonded to the first surface of the current collector sheet.

In aspects of the invention, the fibrillized particles deposited on the first surface are made using a dry process, such as dry-blending and dry fibrillization techniques.

In aspects of the invention, fibrillized particles are further deposited on a second surface of the current collector sheet, and the current collector and the fibrillized particles on the second surface are then calendered to obtain a second active electrode material film bonded to the second surface of the current collector sheet.

In aspects of the invention, the step of calendering the current collector sheet and the fibrillized particles deposited on the first surface and the step of calendering the current collector sheet and the fibrillized particles deposited on the second surface are performed substantially at the same time.

In aspects of the invention, the step of calendering the current collector sheet and the fibrillized particles deposited on the second surface is performed after the step of calendering the current collector sheet and the fibrillized particles deposited on the first surface.

In aspects of the invention, the current collector sheet with the first film and, optionally, the second film bonded to the current collector sheet may be shaped into one or more electrodes. For example, the current collector and the film or films are trimmed to predetermined dimensions.

In aspects of the invention, one or both surfaces of the current collector sheet are pretreated, for example, roughened, before the steps of (1) calendering the current collector sheet and the fibrillized particles deposited on the first surface, and (2) calendering the current collector sheet and the fibrillized particles deposited on the second surface. Pretreatment enhances adhesion of the films to the current collector sheet.

In aspects of the invention, the current collector sheet with the first film (and optionally the second film) bonded to the current collector sheet are calendered at least one additional time to densify the film or films.

In aspects of the invention, calendering includes processing the current collector sheet and the fibrillized particles between rollers of a calender, wherein at least one of the rollers is heated. The roller or rollers may be heated to a temperature between about 100 and about 300 degrees Celsius. The roller or rollers may be heated to a temperature between 150 and 250 degrees Celsius. The roller or rollers may be heated to a temperature between about 195 and about 205 degrees Celsius. The fibrillized particles may also be heated after the step of depositing and before the step of calendering.

In one embodiment, a method of making an electrode comprises providing a substrate; depositing electrode material in the form of particles onto a first surface of the substrate. In one embodiment, the particles deposited on the first surface of the substrate form a first active electrode material film. The particles of electrode material may be deposited onto a bare current collector sheet. The step of providing the particles deposited on the first surface may comprise providing the particles as dry fibrillized particles. The method may further comprise depositing dry fibrillized particles of electrode material on a second surface of the current collector sheet; and calendering the current collector sheet and the dry fibrillized particles deposited on the second surface to obtain a second active electrode material film bonded to the second surface of the current collector sheet. The step of calendering the current collector sheet and the dry fibrillized particles deposited on the first surface and the step of calendering the current collector sheet and the dry fibrillized particles deposited on the second surface may be performed substantially at the same time. The method may further comprise shaping the current collector sheet with the first and second active electrode films bonded to the current collector sheet into one or more double-layer capacitor electrodes. The method may further comprise pretreating the first and the second surfaces of the current collector sheet before the steps of (1) calendering the current collector sheet and the dry fibrillized particles deposited on the first surface, and (2) calendering the current collector sheet and the dry fibrillized particles deposited on the second surface. The method may further comprise at least one additional step of calendering the current collector sheet with the first and second active electrode films bonded to the current collector sheet to densify the first and second films. The step of calendering the current collector sheet and the dry fibrillized particles may comprise processing the current collector sheet and the dry fibrillized particles between rollers of a calender, wherein at least one of the rollers is heated. The dry fibrillized particles may comprise carbon and binder particles. The binder particles may comprise PTFE. The binder particles may comprise thermoset or thermoplastic particles.

In one embodiment, a method of making an electrode may comprise providing a current collector sheet comprising a first surface and a second surface; providing fibrillized particles of active electrode material; moving the current collector sheet between a first roller of a calender and a second roller of the calender while (1) supplying the fibrillized particles between the first surface and the first roller, and (2) supplying the fibrillized particles between the second surface and the second roller. The step of providing fibrillized particles may comprise using a dry process to make the fibrillized particles. The method may comprise heating at least one roller of the first and second calender rollers; wherein the step of heating is performed during the step of moving. In an embodiment that uses thermoset-or thermoplastic particles, heating of one or more rollers may be used to soften or liquefy the particles such that they better effectuate adhesion of the active electrode material to the collector sheet.

In one embodiment, a method of making an electrode may comprise providing particles; processing the particles to obtain dry fibrillized particles; depositing the dry fibrillized particles onto a current collector; processing the dry fibrillized particles and the current collector to obtain a film of active electrode material bonded to the current collector. Processing the particles to obtain dry fibrillized particles may include subjecting the particles to high velocity jets of air.

In one embodiment, an electrode comprises a substrate and a plurality of particles deposited onto the substrate in an uncalandered form. The plurality of particles may comprise dry carbon and dry binder. The particles may comprise dry fibrillized binder.

These and other features and aspects of the present invention will be better understood with reference to the following description, drawings, and appended claims.

### DESCRIPTION OF THE FIGURES

FIG. 1 illustrates selected steps of a process for making an electrode, in accordance with some aspects of the present invention;

FIGS. 2 and 3 illustrate calendering steps of a variant of the process of FIG. 1, in accordance with some aspects of the present invention;

FIG. 4 illustrates selected steps of another process for making an electrode, in accordance with some aspects of the present invention; and

FIG. 5 illustrates calendering step of a variant of the process of FIG. 4, in accordance with some aspects of the present invention.

### DETAILED DESCRIPTION

In this document, the words “embodiment” and “variant” refer to particular apparatus, process, or article of manufacture, and not necessarily to the same apparatus, process, or article of manufacture. Thus, “one embodiment” (or a similar expression) used in one place or context can refer to a particular apparatus, process, or article of manufacture; the same or a similar expression in a different place can refer to a different apparatus, process, or article of manufacture. The expression “alternative embodiment” and similar phrases are used to indicate one of a number of different possible embodiments. The number of potential embodiments is not necessarily limited to two or any other quantity. Characterization of an embodiment as “exemplary” means that the embodiment is used as an example. Such characterization does not necessarily mean that the embodiment is a preferred embodiment; the embodiment may but need not be a currently preferred embodiment.

The expression “active electrode material” and similar phrases signify material that enhances the function of the electrode beyond simply providing a contact or reactive area approximately the size of the visible external surface of the electrode. In a double layer capacitor electrode, for example, a film of active electrode material includes particles with high porosity, so that the surface area of the electrode exposed to an electrolyte in which the electrode is immersed is increased well beyond the area of the visible external surface; in effect, the surface area exposed to the electrolyte becomes a function of the volume of the film made from the active electrode material.

The meaning of the word “film” is similar to the meaning of the words “layer” and “sheet”; “film” does not necessarily imply a particular thickness of the material.

When used to describe making of active electrode material film, the terms “powder,” “particles,” and the like refer to a plurality of granules that are small in relation to the thickness of the active electrode material film.

The references to “fibrillizable binder” and “fibril-forming binder” within this document are intended to convey the meaning of polymers, co-polymers, and similar ultra-high molecular weight substances capable of fibrillation. Such substances are often employed as binder for promoting cohesion in loosely-assembled particulate materials, i.e., active filler materials that perform some useful function in a particular application. “Fibrillized” or “fibrillated” particles are particles of active electrode material mixed with fibrillizable binder and, optionally, with a conduction promoter (and possibly other substances) that have undergone a fibrillation process, such as exposure to high-shear forces.

The words “calender,” “nip,” and “laminator” as used in this document mean a device adapted for pressing and compressing. Pressing may be, but is not necessarily, performed using rollers. When used as verbs, “calender” and “laminate” mean processing in a press, which may, but need not, include rollers.

Other and further definitions and clarifications of definitions may be found throughout this document.

Reference will now be made in detail to several embodiments of the invention that are illustrated in the accompanying drawings. Same reference numerals may be used in the drawings and the description to refer to the same or like parts or steps. The drawings are in simplified form and not to precise scale. For purposes of convenience and clarity only, directional terms, such as top, bottom, left, right, up, down, over, above, below, beneath, rear, and front may be used with respect to the accompanying drawings. These and similar directional terms should not be construed to limit the scope of the invention.

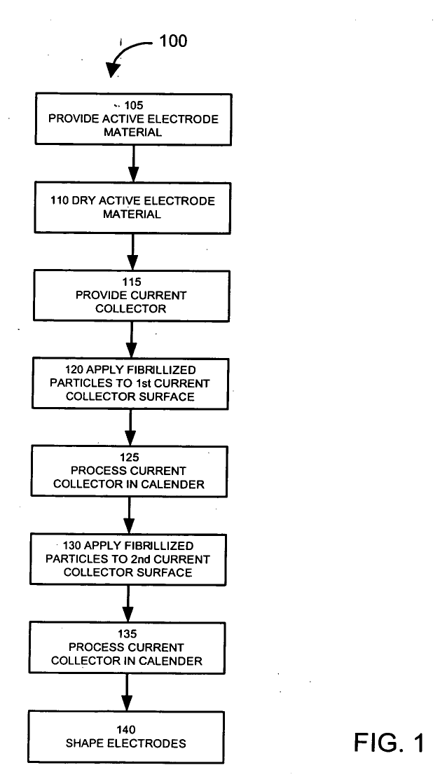

Referring more particularly to the drawings, FIG. 1 illustrates selected steps of a process 100 for fabricating an electrode of a double layer capacitor. Although the process steps are described serially, certain steps may also be performed in conjunction or in parallel, in a pipelined manner, or otherwise. There is no particular requirement that the steps be performed in the same order in which this description lists them, except where explicitly so indicated, otherwise made clear from the context, or inherently required. Not all illustrated steps are strictly necessary, while other optional steps may be added to the process 100. A high level overview of the process 100 is provided immediately below; more detailed explanations of the steps of the process 100 and variants of the steps are provided following the overview.

In step 105, particles of active electrode material are provided. In a preferred embodiment, the particles are fibrillized. In step 110, if needed, the fibrillized particles may exposed to heat to evaporate any moisture that may be present within the active electrode material. In step 115, a substrate is provided. In a preferred embodiment, the substrate comprises a current collector. In step 120, the fibrillized particles obtained in the steps 105 and 110 are applied to a first surface of the current collector. In step 125, the current collector with the fibrillized particles is processed in a calender. Calendering of the fibrillized particles onto the first surface of the current collector results in formation of a first film of active electrode material bonded to the first surface of the current collector.

In step 130, the current collector with the first film bonded to it is turned over and additional fibrillized particles from the steps 105 and 110 are applied to a second surface of the current collector, substantially as was done in the step 120. In step 135, the current collector is again processed in a calender, which may be the same calender as was used in the step 125 or another calender. After the step 135, the fibrillized particles on the second surface of the current collector form a second film of active electrode material. The second film is bonded to the second surface of the current collector sheet. In step 140, the electrode product sheet (i.e., the current collector sheet with the two films of active electrode material on its opposite surfaces) is shaped into one or more electrodes/electrode assemblies for use in double layer capacitors.

We now turn to a more detailed description of the individual steps of the process 100, beginning with the step 105 in which particles of fibrillized active electrode material are provided.

According to one process for obtaining fibrillized active electrode material, a dry blend of particles and fibrillizable binder are dry fibrillized to form a dry powder material. This is preferably done without addition of liquids, solvents, processing aids impurities, or the like to the mixture. Dry fibrillization is described in more detail in a co-pending commonly-assigned U.S. patent application Ser. No. 11/116,882. This application is hereby incorporated by reference as if fully set forth herein, including all figures, tables, and claims.

Dry-blending may be carried out, for example, for 1 to 10 minutes in a V-blender equipped with a high intensity mixing bar, until a uniform dry mixture of dry particles and dry binder is formed. Those skilled in the art will identify, after perusal of this document, that blending time can vary based on batch size, materials, particle size, densities, as well as other properties, and yet remain within the scope of the present invention.

After dry-blending, the fibrillizable binder in the resulting dry powder material may be dry fibrillized (fibrillated) using non-lubricated high-shear force techniques. In a preferred embodiment, high-shear forces are provided by a jet-mill. The dry powder material is introduced into the jet-mill, wherein high-velocity air jets are directed at the dry powder material to effectuate application of high shear to the fibrillizable binder within the dry powder material. The shear forces that arise during the dry fibrillization process physically stretch the fibrillizable binder, causing the binder to form a network of fibers that bind the binder to other particles in the active electrode material.

Although additives, such as solvents, liquids, and the like, are not necessarily used in the manufacture of certain embodiments disclosed herein, a certain amount of impurity, for example, moisture, may be absorbed by the active electrode material from the surrounding environment. Those skilled in the art will understand, after perusal of this document that the dry particles used with embodiments and processes disclosed herein may also, prior to being provided by particle manufacturers as dry particles, have themselves been preprocessed with additives and, thus, contain one or more pre-process residues. For these reasons, one or more of the embodiments and processes disclosed herein may utilize a drying step at some point before a final electrolyte impregnation step, so as to remove or reduce the aforementioned pre-process residues and impurities. It is identified that even after one or more drying steps, trace amounts of the aforementioned moisture, residues, and impurities that may be present in the active electrode material and an electrode film made therefrom.

It should also be noted that references to dry-blending, dry-fibrillization, dry particles, and other dry materials' and processes used in the manufacture of the active electrode material and films do not exclude the use of other than dry processes as described herein, for example, as may be achieved after drying of particles and films that may have been previously prepared using a processing aid, liquid, solvent, or the like.

In some embodiments, the active electrode material comprises activated carbon, and conductive carbon or graphite. Suitable activated carbon materials are available from a variety of sources known to those skilled in the art.

Fibrillizable binders used in electrode embodiments in accordance with the present invention may include, without limitation, polytetraflouroethylene (PTFE or Teflon®), polypropylene, polyethylene, co-polymers, and various polymer blends.

In various embodiments, proportions of activated carbon, conductive carbon, and binder range as follows: 85-90 percent by weight of activated carbon, 5-15 percent by weight of PTFE, and 0-10 percent by weight of conductive carbon. More specific exemplary embodiments contain 85-93 percent of activated carbon, 3-8 percent of PTFE, and 2-10 percent of conductive carbon. Other ranges are within the scope of the present invention as well.

In one embodiment, binder may further comprise a polymer/resin or thermoplastic comprises that may enhance bonding of the active electrode material to a bare collector. In one embodiment, binder may comprise polypropylene or polypropylene oxide particles. In one embodiment, thermoplastic material may be selected from polyolefin classes of thermoplastic known to those skilled in the art. Other thermoplastics of interest and envisioned for potential use include homo and copolymers, olefinic oxides, rubbers, butadiene rubbers, nitrile rubbers, polyisobutylene, poly(vinylesters), poly(vinylacetates), polyacrylate, fluorocarbon polymers, with a choice of thermoplastic dictated by its melting point, metal adhesion, and electrochemical and solvent stability in the presence of a subsequently used electrolyte. In other embodiments, thermoset and/or radiation set type binders are envisioned as being useful. The present invention, therefore, should not be limited by the disclosed and suggested binders, but only by the claims that follow.

When needed, drying step 110 may involve air-drying active electrode material. Alternatively, the particles may be force-dried at an elevated temperature. For example, particles may be subjected to a temperature between about 100 and 150 degrees Celsius. Drying step 110 may be performed prior to or after a fibrillization step.

The current collector provided in the step 115 may be made of a sheet of conductive material, such as metal sheet, foil, screen, or mesh. In one embodiment, the current collector is a sheet of aluminum foil approximately 40 microns thick. In alternative embodiments, the thickness of the foil is between about 20 and about 100 microns. In other, more specific embodiments, the thickness of the aluminum foil is between about 30 and about 50 microns. In still other alternative embodiments, the current collector is relatively thick and is better described as a plate.

Conductive materials other than aluminum can also be used in the current collector. These materials include, for example, silver, copper, gold, platinum, palladium, steel, and tantalum, as well as various alloys of these metals. Non-metal materials are also potential candidates for use in the current collector.

In some embodiments, the current collector may be pretreated to enhance its adhesion properties. Pretreatment of the current collector may include mechanical roughing, chemical pitting, and/or use of a surface activation treatment, such as corona discharge, active plasma, ultraviolet, laser, or high frequency treatment methods known to a person skilled in the art.

Turning next to the step 120, the fibrillized particles of active electrode material are applied to the first surface of the current collector. For example, the fibrillized particles may be dispersed onto the current collector using a powder or particle scatter coater, a doctor blade system, or a scatter head, which are used by those skilled in the art. Such apparatus have in common that the active electrode material is deposited onto a current collector in a non-film, non-liquid, and non-slurry form. The active electrode material may also be sprinkled by hand onto the current collector. In some process embodiments, the current collector sheet is vibrated slightly during or after the dispersal of the fibrillized particles, in order to improve evenness of the distribution of the particles over the surface of the current collector sheet.

In various embodiments, the average thickness of the fibrillized particles layer on the current collector sheet is between about 150 and 900 microns. In more specific embodiments, the thickness of the layer (before calendering) is between about 200 and 350 microns.

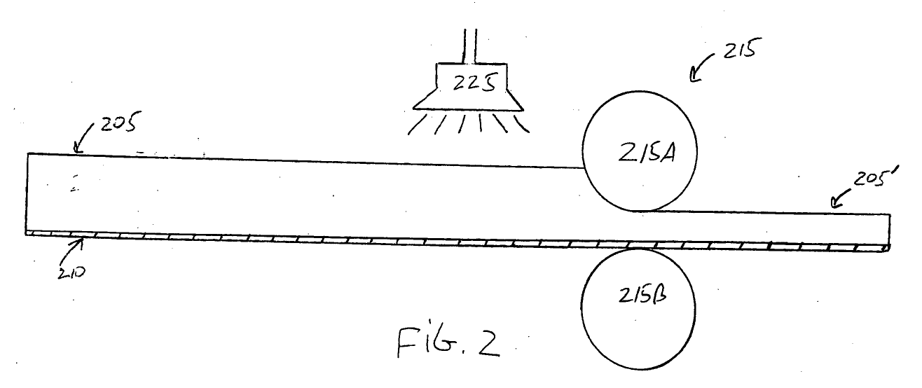

The calendering step 125 of a variant of the process 100 is illustrated in FIG. 2. A layer 205 of fibrillized particles of active electrode material has been deposited on top of a current collector sheet 210, and the resulting combination is fed between rollers 215A and 215B of a calender 215. In one embodiment, each of the rollers 215A and 215B has a diameter of about six inches (152 mm) and a working surface (width) of about 13 inches (330 mm). In this embodiment, the rollers 215A and 215B rotate so that the current collector sheet 210 and the layer 205 are processed at the rate of between about 12 inches (305 mm) per minute and about 120 inches (3,050 mm) per minute.

One or both of the rollers 215A/B may be heated in order to soften binder in the fibrillized particle layer 205, effectuating good adhesion of the active electrode material to the current collector sheet 210. In one variant of the embodiment, the surface temperature of the rollers 215A/B is between about 100 and 300 degrees Celsius (212 and 572 degrees Fahrenheit). In a more specific variant, the surface temperature of the rollers 215A/B is between 150 and 250 degrees Celsius (302 and 482 degrees Fahrenheit). In a still more specific embodiment, the surface temperature of the rollers is set between 195 and 205 degrees Celsius (383 and 401 degrees Fahrenheit). In some embodiments, the surface temperature of the rollers 215A/B is selected high enough to melt polymer/resin and/or thermoplastic binder particles present in the active electrode material in the layer 205, while sufficiently low to avoid their decomposition. Furthermore, the layer 205 may be preheated before it enters the calender 215. For example, an infrared radiator/heater 225 may be positioned as shown in FIG. 2 to elevate the temperature of the layer 205.

In one embodiment, the calender pressure is set in the range between about 50 and 1000 pounds per linear inch (PLI) of the width of the current collector sheet 210. In a more specific embodiment, the calender pressure is set in the range between 350 and 650 PLI. In a still more specific embodiment, the calender pressure is set between 450 and 550 PLI. In a particular embodiment, the calender pressure is set to about 500 PLI.

The calendering step may also be controlled by setting the gap between the rollers 215A/B. In some embodiments, the gap between the rollers 215A and 215B is set to compress the fibrillized particles layer 205 to between 25 and 60 percent of its pre-calendering thickness. In a more specific embodiment, the gap is set to compress the layer 205 to between 35 and 40 percent of its original thickness.

At the output of the calender 215, the layer 205 transforms into an active electrode film 205′, which is laminated (bonded) to the current collector sheet 210. Note that the thickness of the film 205′ may and usually does rebound slightly at the exit from the calender 215.

In the step 130, the current collector sheet 210 is turned over and additional fibrillized particles are applied onto its second surface, forming a fibrillized particles layer 220. This can be done similarly to the step 120 discussed above. In embodiments with symmetric electrodes, the thickness of the layer 220 is approximately the same as the thickness of the layer 205. In embodiments with asymmetric electrodes, the thickness of the layer 220 may differ from that of the layer 205.

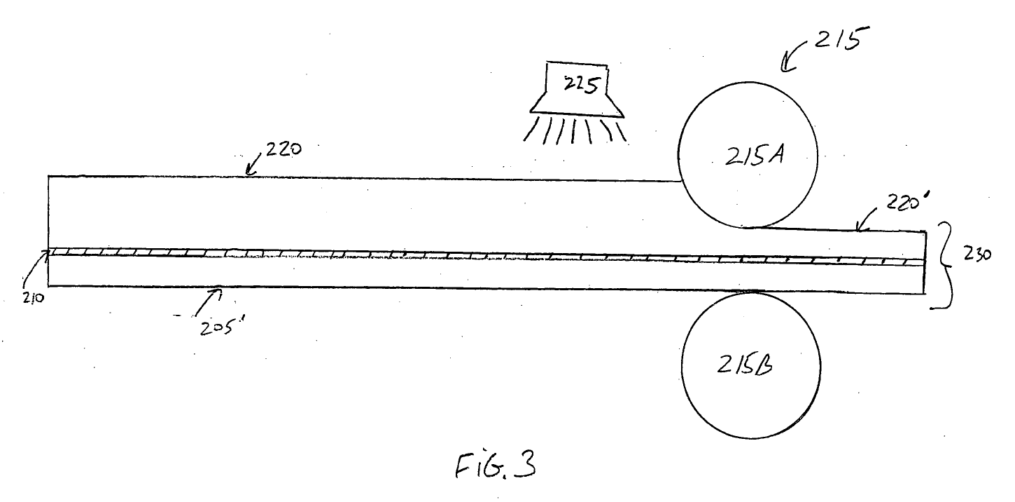

The step 135 is substantially similar to the step 125. As illustrated in FIG. 3, the current collector 210 with the film 205′ on its bottom and the layer 220 on its top is fed between the rollers 215A/B of the calender 215. Note that in some embodiments the same calender is used in both steps 125 and 135, while in other embodiments a different calender is used to perform these steps. Note also that the gap between the rollers 215A/B may need to be increased in the step 135 to accommodate the additional thickness of the film 205′.

At the calender output, the layer 220 transforms into an active electrode film 220′, which is laminated to the second surface of the current collector sheet 210. An electrode product sheet 230, which includes the current collector sheet 210 and the films 205′ and 220′, thus results. The electrode product sheet 230 may be processed in a calender one or more additional times in order to densify the films 205′ and 220′, and to improve the bond between the current collector 210 and the active electrode films 205′ and 220′.

At the step 140, the electrode product sheet 230 is shaped for use as electrodes, for example, trimmed to predetermined dimensions. Terminals may be attached to the electrodes as part of this step.

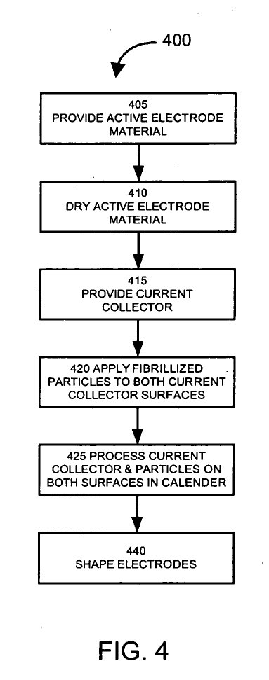

In some process embodiments, both active electrode films may be formed and bonded to the current collector at the same time. FIG. 4 illustrates one such process 400. Some of the steps of the process 400 are similar or identical to the corresponding and similarly numbered steps of the process 100. Fibrillized particles of active electrode material are provided in step 405. In step 410, the fibrillized particles may be dried. In step 415, a current collector sheet is provided. In step 420, the fibrillized particles are applied to both surfaces of the current collector sheet. In step 425, the current collector and the fibrillized particles are processed in a calender, simultaneously forming and bonding active electrode films on both surfaces of the current collector sheet. Finally, in step 440 the electrode product sheet obtained in the step 425 is trimmed or otherwise shaped into electrodes.

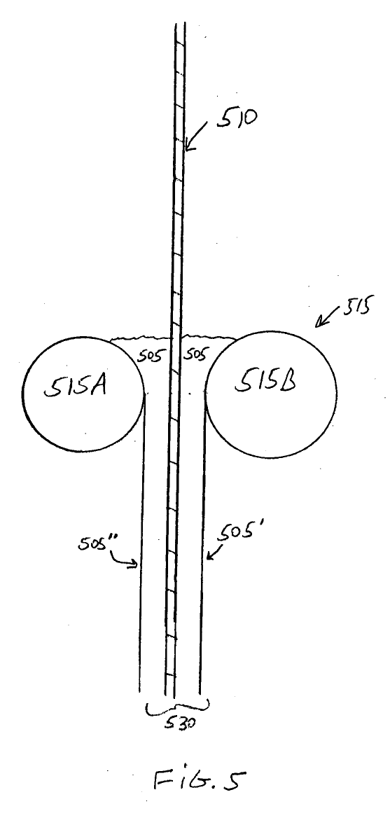

FIG. 5 illustrates in more detail the fibrillized particles application of the step 420 and the calendering of the step 425. The current collector sheet 510 from the step 415 is disposed vertically and fed between rollers 515A and 515B of a calender 515. Fibrillized particles 505 from the steps 405 and 410 are directed onto each side of the current collector 510 between the current collector sheet 510 and the corresponding roller 515A or 515B, as shown in the Figure. The fibrillized particles 505 and the current collector sheet 510 are calendered, resulting in active electrode films 505′ and 505″ bonded to the opposite surfaces of the current collector sheet 510. An electrode product sheet 530 exits at the bottom of the calender 515. Dimensions, temperatures, pressures, and other operating characteristics of the calender 515 may be identical or similar to the corresponding parameters of the calender 215 described above in relation to the process 100.

The electrodes obtained in the steps 140 and 540 may be used in double layer capacitors and other electrical energy storage devices. The basic structure of a double layer capacitor has already been described.

The inventive electrode fabrication processes and the electrodes made using such processes have been described above in considerable detail. This was done for illustration purposes. Neither the specific embodiments of the invention as a whole, nor those of its features, limit the general principles underlying the invention. In particular, the invention is not necessarily limited to the disclosed constituent materials and proportions of constituent materials used for fabricating the electrodes. For example, although in embodiments described above an adhesive layer is disclosed as not being a constituent material used in the manufacture of an electrode, it is contemplated that deposition of dry fibrillized particles onto an electrode with a pre-applied layer of adhesive is within the scope of the present invention. Additionally, the present invention contemplates that dry particles may be deposited on other substrates, for example, other electrode films, separators, and other electrode structures. The invention is also not necessarily limited to electrodes used in double layer capacitors, but extends to other electrode applications. The specific features described herein may be used in some embodiments, but not in others, without departure from the spirit and scope of the invention as set forth. Many additional modifications are intended in the foregoing disclosure, and it will be appreciated by those of ordinary skill in the art that, in some instances, some features of the invention will be employed in the absence of a corresponding use of other features. The illustrative examples therefore do not define the metes and bounds of the invention and the legal protection afforded the invention, which function is served by the claims and their equivalents.

1. A method of making an electrode, the method comprising:
providing a substrate;
depositing electrode material in the form of particles onto a first surface of the substrate; and
calendering the substrate and the particles deposited on the first surface to obtain a first active electrode material film bonded to the first surface of the substrate.

2. A method according to claim 1, wherein the step of depositing particles on the first surface of the substrate comprises providing the particles as dry particles.

3. A method according to claim 2, wherein the substrate comprises a bare current collector, and wherein when calandered the particles form a first active electrode material film.

4. A method according to claim 3, further comprising:
depositing dry particles of electrode material on a second surface of the current collector; and
calendering the current collector and the dry particles deposited on the second surface to obtain a second active electrode material film bonded to the second surface of the current collector.

5. A method according to claim 4, wherein the step of calendering the current collector and the dry particles deposited on the first surface and the step of calendering the current collector and the dry particles deposited on the second surface are performed substantially at the same time.

6. A method according to claim 4, further comprising shaping the current collector with the first and second active electrode films bonded to the current collector into one or more double-layer capacitor electrodes.

7. A method according to claim 4, further comprising:
pretreating the first and the second surfaces of the current collector before the steps of (1) calendering the current collector and the dry particles deposited on the first surface, and (2) calendering the current collector and the dry particles deposited on the second surface.

8. A method according to claim 4, further comprising at least one additional step of calendering the current collector with the first and second active electrode films bonded to the current collector to densify the first and second films.

9. A method according to claim 3, wherein the step of calendering the current collector and the dry particles comprises processing the current collector and the dry particles between rollers of a calender, wherein at least one of the rollers is heated.

10. A method according to claim 3, wherein the dry particles comprise carbon and binder particles.

11. A method according to claim 10, wherein the binder particles comprise PTFE.

12. A method according to claim 11, wherein the binder particles comprise thermoset or thermoplastic particles.

13. A method of making an electrode, the method comprising:
providing a current collector comprising a first surface and a second surface;
providing particles of active electrode material; and
moving the current collector between a first roller of a calender and a second roller of the calender while (1) supplying the particles between the first surface and the first roller, and (2) supplying the particles between the second surface and the second roller.

14. A method according to claim 13, wherein the step of providing particles comprises using a dry process.

15. A method according to claim 13, further comprising:
heating at least one roller of the first and second calender rollers; and
wherein the step of heating is performed during the step of moving.

16. A method of making an electrode, the method comprising:
providing particles;
processing the particles to obtain dry fibrillized particles;
depositing the dry fibrillized particles onto a current collector; and
processing the dry fibrillized particles and the current collector to obtain a film of active electrode material bonded to the current collector.

17. A method according to claim 16, wherein the processing the particles to obtain dry fibrillized particles includes subjecting the particles to high velocity jets of air.

18. An electrode, comprising:
a substrate; and
a plurality of particles deposited onto the substrate in an uncalandered form.

19. An electrode according to claim 18, wherein the plurality of particles comprise dry carbon and dry binder.

20. An electrode according to claim 18, wherein the particles comprise dry fibrillized binder.
